(19) United States
(12) Patent Application Publication
(10) Pub. No.: US 2026/0077293 A1
(43) Pub. Date: Mar. 19, 2026

(54) Systems and Methods for Purification of Ammonia Using Adsorption Media

(71) Applicant: Bechtel Energy Technologies & Solutions, Inc., Houston, TX (US)

(72) Inventors: Martin Taylor, Houston, TX (US); Charles Kimtantas, Sugar Land, TX (US)

(73) Assignee: Bechtel Energy Technologies & Solutions, Inc., Houston, TX (US)

(21) Appl. No.: 19/106,078

(22) PCT Filed: Jun. 20, 2024
(86) PCT No.: PCT/US24/34661

§ 371 Date: Feb. 24, 2025

Related U.S. Application Data
(60) Provisional application No. 63/509,459, filed on Jun. 21, 2023.

(51) Int. Cl. B01D 53/04; B01D 53/00; C01C 1/02

(52) U.S. Cl. CPC B01D 53/0438; B01D 53/002; B01D 53/0446; C01C 1/024; B01D 2253/102; B01D 2259/40003

(57) ABSTRACT

Systems and methods for purification of ammonia from an ammonia liquid feed stream, particularly ammonia recovered from a 2-column SWS unit, by vaporizing the ammonia liquid feed stream to produce a very cold (potentially subzero) ammonia vapor stream and passing the cooled ammonia vapor stream through an adsorption media such as activated to remove impurities from the cooled ammonia vapor stream and produce a purified ammonia vapor stream.

### CROSS-REFERENCE TO RELATED APPLICATIONS

This application claims priority to U.S. Provisional Application No. 63/509,459 filed Jun. 21, 2023, which is incorporated herein by reference. This application and U.S. Pat. Nos. 10,022,650, 10,702,799, 10,850,226, 10,266,418, 10,456,735, 10,843,122, and 10,315,153, each of which are also incorporated herein by reference, are commonly assigned to Bechtel Energy Technologies and Solutions, Inc

### FIELD OF THE INVENTION

The present disclosure generally relates to systems and methods for purification of ammonia using adsorption media. More particularly, the systems and methods improve the purification of ammonia from an ammonia liquid feed stream by vaporizing the ammonia liquid feed stream to produce a very cold (potentially subzero) ammonia vapor stream and passing the cooled ammonia vapor stream through an adsorption media such as activated carbon to remove impurities from the cooled ammonia vapor stream and produce a purified ammonia vapor stream.

### BACKGROUND OF THE INVENTION

There is a known issue with ammonia recovered from certain 2-column sour water stripper (“SWS”) units where the anhydrous ammonia product has an offensive odor. Apparently, humans can smell some odors at sub-ppm levels that exist in an equilibrium with other precursors. Removing the odor is difficult as the equilibrium causes it to reform. If a project, for example, is required to use the recovered ammonia, market ammonia must be purchased, instead, as the project may be forced to incinerate the recovered ammonia.

### BRIEF DESCRIPTION OF THE DRAWINGS

The detailed description is described below with reference to the accompanying drawing, in which like elements are referenced with like reference numbers, in which:

FIG. 1 is a schematic diagram illustrating one embodiment of an ammonia purification system using activated carbon.

### DETAILED DESCRIPTION OF THE PREFERRED EMBODIMENTS

The subject matter of the present disclosure is described with specificity, however, the description itself is not intended to limit the scope of the disclosure. The subject matter thus, might also be embodied in other ways, to include different structures, steps and/or combinations similar to and/or fewer than those described herein, in conjunction with other present or future technologies. Although the term “step” may be used herein to describe different elements of methods employed, the term should not be interpreted as implying any particular order among or between various steps herein disclosed unless otherwise expressly limited by the description to a particular order. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures and dimensions described herein are only exemplary and are not intended to assert or imply any limitation with regard to the environment, architecture, design, or process in which different embodiments may be implemented. To the extent that temperatures and/or pressures are referred to in the following description, those conditions are merely illustrative and are not meant to limit the disclosure. All streams described herein are carried by physical lines.

The systems and methods disclosed herein address the issues associated with purification of ammonia from an ammonia liquid feed stream, particularly ammonia recovered from a 2-column SWS unit, by vaporizing the ammonia liquid feed stream to produce a very cold (potentially subzero) ammonia vapor stream and passing the cooled ammonia vapor stream through an adsorption media such as activated carbon to remove impurities from the cooled ammonia vapor stream and produce a purified ammonia vapor stream.

In one embodiment, a system is disclosed for purifying ammonia, which comprises: i) an ammonia liquid feed stream; ii) a valve in fluid communication with the ammonia liquid feed stream for vaporizing the ammonia liquid feed stream and producing a cooled ammonia vapor stream; and iii) a vessel comprising an adsorption media in fluid communication with the cooled ammonia vapor stream and producing a purified ammonia vapor stream.

In another embodiment, a method is disclosed for purifying ammonia, which comprises: i) vaporizing an ammonia liquid feed stream to produce a cooled ammonia vapor stream; and ii) passing the cooled ammonia vapor stream through a vessel comprising an adsorption media to remove impurities from the cooled ammonia vapor stream and produce a purified ammonia vapor stream.

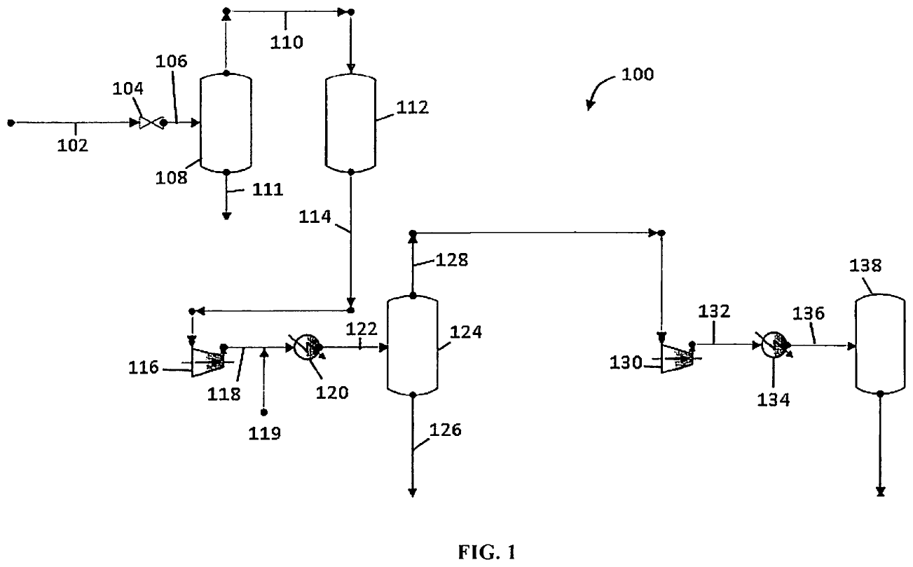

Referring now to FIG. 1, a schematic diagram illustrates one embodiment of an ammonia purification system 100. An ammonia liquid feed stream 102 is fed through an auto-refrigerating valve 104, where it is vaporized by reducing pressure thus, being cooled to at least 50° F. and preferably as low as about −30° F. The cooled ammonia liquid feed stream 106 from valve 104 may be optionally fed to a separating drum 108 to produce a cold-flashed vapor stream 110 and a disposable liquid stream 111 if the ammonia liquid feed stream 102 is not completely vaporized and a portion of the ammonia liquid feed stream 102 (0%-50%, more preferably 0%-10%) is maintained as a liquid. The idea is that some of the offending molecules may not vaporize and can be removed as a liquid, which will then be separately disposed.

The cold-flashed vapor stream 110 passes through an activated carbon vessel 112 (up flow or downflow) where it passes over, around and through activated carbon (with additives or not) and/or other adsorption, absorption, or chemisorption media such as silica gel, diatomaceous earth, any form of alumina (alpha, beta, or gamma forms; activated or not; with additives or not), or resin to produce a purified ammonia vapor stream 114. The purified ammonia vapor stream 114 is then fed through a first compressor 116 to produce another purified ammonia vapor stream 118.

Optionally, a water stream 119 may be introduced either upstream or downstream of the first compressor 116 to improve the quality of the final ammonia product.

The another purified ammonia vapor stream 118 and water stream 119 are then fed to an interstage cooler 120 to produce a two-phase fluid stream 122, which is fed to an interstage knock-out drum 124. The interstage knock-out drum 124 separates the two-phase fluid stream 122 into a condensed disposable liquid stream 126 and a partially recompressed vapor stream 128. The partially recompressed vapor stream 128 may be further compressed in a second compressor 130 to produce a recompressed ammonia vapor stream 132. The recompressed ammonia vapor stream 132 is condensed in a condenser 134 to produce a purified ammonia stream 136, which may be collected in an accumulator drum 138. The systems and methods disclosed herein thus allow superior purification of recovered ammonia that otherwise may be lost due to unremoved impurities. The systems and methods disclosed herein further address the issues associated with ammonia recovered from 2-column SWS units.

While the present disclosure has been described in connection with presently preferred embodiments, it will be understood by those skilled in the art that it is not intended to limit the disclosure of those embodiments. It is therefore contemplated that various alternative embodiments and modifications may be made to the disclosed embodiments without departing from the spirit and scope of the disclosure defined by the appended claims and equivalents thereof.

1. A system for purifying ammonia, comprising:
an ammonia liquid feed stream;
a valve fluidly connected to the ammonia liquid feed stream and a cooled ammonia vapor stream for vaporizing the ammonia liquid feed stream and producing the cooled ammonia vapor stream; and
a vessel comprising an adsorption media in fluid communication with the cooled ammonia vapor stream for removing impurities from the cooled ammonia vapor stream and producing a purified ammonia vapor stream.

2. The system of claim 1, wherein the cooled ammonia vapor stream is cooled to a temperature of about 50° F. to about −30° F. using an auto-refrigeration valve.

3. The system of claim 1, wherein the adsorption media comprises activated carbon.

4. The system of claim 1, further comprising a separating drum positioned between the cooled ammonia vapor stream and the vessel for removing any liquid from the cooled ammonia vapor stream.

5. The system of claim 1, further comprising a first compressor in fluid communication with the purified ammonia vapor stream for compressing the purified ammonia vapor stream into another purified ammonia vapor stream.

6. The system of claim 5, further comprising a water stream in fluid communication with the another purified ammonia vapor stream.

7. The system of claim 6, further comprising an interstage cooler in fluid communication with the water stream and the another purified ammonia vapor stream for producing a two-phase fluid stream comprising water and purified ammonia.

8. The system of claim 7, further comprising a knock-out drum in fluid communication with the two-phase fluid stream for separating the two-phase fluid stream into a condensed disposable liquid stream and a partially recompressed vapor stream.

9. The system of claim 8, further comprising a second compressor in fluid communication with the partially recompressed vapor stream for compressing the partially recompressed vapor stream into a recompressed ammonia vapor stream.

10. The system of claim 9, further comprising a condenser in fluid communication with the recompressed ammonia vapor stream for condensing the recompressed ammonia vapor stream into a purified ammonia stream.

11. A method for purifying ammonia, comprising:
vaporizing an ammonia liquid feed stream with a valve to produce a cooled ammonia vapor stream; and
passing the cooled ammonia vapor stream through a vessel comprising an adsorption media to remove impurities from the cooled ammonia vapor stream and produce a purified ammonia vapor stream.

12. The method of claim 11, wherein the cooled ammonia vapor stream is cooled to a temperature of about 50° F. to about −30° F. using an auto-refrigeration valve.

13. The method of claim 11, wherein the adsorption media comprises activated carbon.

14. The method of claim 11, further comprising removing any liquid from the cooled ammonia vapor stream.

15. The method of claim 11, further comprising compressing the purified ammonia vapor stream into another purified ammonia vapor stream.

16. The method of claim 15, further comprising mixing a water stream with the another purified ammonia vapor stream to produce a mixed liquid stream.

17. The method of claim 16, further comprising cooling the mixed liquid stream to produce a two-phase fluid stream comprising water and purified ammonia.

18. The method of claim 17, further comprising separating the two-phase fluid stream into a condensed disposable liquid stream and a partially recompressed vapor stream.

19. The method of claim 18, further comprising compressing the partially recompressed vapor stream into a recompressed ammonia vapor stream.

20. The method of claim 19, further comprising condensing the recompressed ammonia vapor stream into a purified ammonia stream.
